(19) United States
(12) Patent Application Publication
(10) Pub. No.: US 2022/0264888 A1
(43) Pub. Date: Aug. 25, 2022

(54) ANTIBACTERIAL FIBER, PREPARATION METHOD THEREOF AND ANTIBACTERIAL TEXTILE PRODUCT

(71) Applicant: HARVEST SPF TEXTILE (BEIJING) CO., LTD., Beijing (CN)

(72) Inventors: Dongdong Xu, Beijing (CN); Xinyuan Xu, Beijing (CN)

(21) Appl. No.: 17/225,098

(22) Filed: Apr. 7, 2021

(30) Foreign Application Priority Data
Feb. 25, 2021 (CN) 202110212451.1

(51) Int. Cl. A01N 59/20; A01N 25/34; A01N 25/08; D06M 16/00; D06M 11/83

(52) U.S. Cl. CPC A01N 59/20; A01N 25/34; A01N 25/08; D06M 16/00; D06M 11/83

(57) ABSTRACT

The present application relates to the field of textiles, and particularly discloses an antibacterial fiber, a preparation method thereof, and an antibacterial textile product. A preparation method of an antibacterial fiber includes the steps of: opening textile fibers, and spraying the textile fibers with organic complex copper solution by a mass ratio of the organic complex copper solution to the textile fiber of 1:(2-4) to provide an antibacterial fiber. An antibacterial fiber made by the preparation method and a textile product made from the antibacterial fiber are further disclosed in the present application.

### CROSS-REFERENCE TO RELATED APPLICATION

The present application is based on and claims the priority benefits of China application No. 202110212451.1, filed on Feb. 25, 2021. The entirety of the above-mentioned patent application is hereby incorporated by reference herein and made a part of this specification.

### BACKGROUND

### Technical Field

The application relates to the field of textiles, and in particular, to an antibacterial fiber, a preparation method thereof and an antibacterial textile.

### Description of Related Art

With the rapid development of modern industrial technologies, the technologies in textile industry are gaining progress rapidly. Textiles and clothing play an irreplaceable role in our daily life. With the continuous improvement of people's quality of life, textiles with utility functions are finding increasing favor with people and getting more attention, especially the textiles with antibacterial effect become more and more important.

There are mainly two kinds of antibacterial technologies for textiles. One is antibacterial finishing, which includes applying an antibacterial agent onto the fiber and fixing it in the textile by impregnation, padding or the like during the process of textile finishing. This method is relatively simple, but suffers from poor washability and short duration of antibacterial effect. At the same time, a certain amount of waste water will be produced in the process, which leads to environmental pollution and brings difficulties to wastewater processing procedure of a dyeing plant.

The other one is a blend spinning method, in which an antibacterial agent, a dispersant, and other auxiliaries are mixed with a fiber matrix resin to produce an antibacterial fiber by melt spinning. That is, the antibacterial agent is made into antibacterial masterbatch, and then blended with raw materials for melt spinning. This method has durable antibacterial effect and good washability. However, in this method, the antibacterial agent needs to be prepared into antibacterial masterbatch first, and then blended with raw materials for melt spinning. Therefore, the spinnability of the antibacterial masterbatch has to be taken into consideration, and the performance of a final product is largely determined by the antibacterial masterbatch, so that this method suffers from the disadvantages of requiring a high technology level, being difficult in operation, and involving a wide range of fields, high requirements for antibacterial agents, complicated operation, and currently low degree of industrialization. Further, this method adopts contact sterilization, by which only a small part of the fibers processed in this way can function on the surface of the fiber, leading to limited antibacterial effect.

Therefore, although a wide range of antibacterial textiles are made by antibacterial finishing at present, an antibacterial fiber will become the main development direction in this industry due to durable antibacterial performance thereof. Considering the fact that the demand for an antibacterial fiber is growing rapidly at a rate of 20% every year, it is necessary to develop a simpler and more convenient method for preparing an antibacterial fiber with durable antibacterial effect.

### SUMMARY

In order to provide an antibacterial fiber which can be simply and conveniently manipulated and has durable antibacterial effect, the present application provides an antibacterial fiber, a preparation method thereof and an antibacterial textile product.

In a first aspect, the present application provides a preparation method of an antibacterial fiber adopting the following technical solutions.

A preparation method of an antibacterial fiber includes the following steps of:

opening textile fibers, and spraying the textile fibers with organic complex copper solution by a mass ratio of the organic complex copper solution to the textile fiber of 1:(2-4) to provide an antibacterial fiber.

In the above technical solution, the textile fiber is first opened to loosen cotton, and large pieces of fibers are torn into small fiber bundles to weaken the contact force between fibers and impurities to remove the impurities. At the same time, opening the textile fiber mixes the fibers, which is conducive to improving the quality of yarns in subsequent procedures. Then, organic complex copper solution is sprayed on the fibers, so as to make full use of the antibacterial and anti-virus effects of copper element. By spraying the organic complex copper solution in a spray form onto the textile fibers and then drying, the copper element can be present on the textile fiber in the form of complex copper ions, and chemically chelate with the hydroxyl groups on the fibers to form a firmer binding between the complex copper ions and the fibers. Thus obtained antibacterial fibers are subjected to subsequent carding and drawing operations for finishing and mixing the textile fibers, so that the fibers sprayed with organic complex copper and the fibers not sprayed with organic complex copper can be mixed evenly, and in turn organic complex copper fibers can be uniformly distributed in the textiles made from the fibers after subsequent procedures to provide final antibacterial textiles. The resultant antibacterial fibers and textile products have durable antibacterial performance due to the chelation between the complex copper and the fibers.

The preparation method according to the present application is simple for operation, including merely spraying the textile fibers with organic complex copper solution, in spite of even or uneven spraying, as long as it is guaranteed that one lot of the textile fibers is sprayed with sufficient amount of organic complex copper solution, since the fibers combined with the organic complex copper can be uniformly mixed with other fibers in subsequent carding and drawing procedures to provide a textile product with uniformly distributed organic complex copper antibacterial fibers. In addition, the chemical chelation between the complex copper and the fibers provides a firmer combining therebetween, providing more durable antibacterial performance. Further, spraying the organic complex copper solution in the present application will not produce wastewater which otherwise would be produced by impregnation, etc., eliminating the need of discharging or processing wastewater, and thus is simpler and more environmentally friendly in operation. Compared with blend spinning, the preparation method according to the present application eliminates the need of preparing or controlling antibacterial masterbatch, involving simpler operation and providing better antibacterial effect.

In a second aspect, the present application provides an antibacterial fiber adopting the following technical solutions.

An antibacterial fiber is prepared by using a preparation method in the first aspect.

In the above technical solution, by making use of the chemical chelation between free hydroxyl groups on the fibers and the complex copper ions, excellent antibacterial performance of complex copper ions, and strong combining with the fibers, the antibacterial fibers obtained according to the present application possess not only excellent antibacterial performance but also excellent antibacterial durability.

In a third aspect, the present application provides an antibacterial textile product adopting the following technical solutions.

An antibacterial textile product is obtainable from the antibacterial fibers in the second aspect.

In the above technical solution, an antibacterial textile product made from the antibacterial fibers possessing excellent antibacterial performance and antibacterial durability according to the present application has excellent antibacterial performance and antibacterial durability.

In summary, the present application provides the following advantages.

1. In the present application, the organic complex copper solution is sprayed onto a textile fiber in a spray form, so that the complex copper is chemically chelated with hydroxyl groups on the fibers, and, after drying, complex copper ions are more firmly combined with the fibers. By making use of the antibacterial effect and anti-virus effect of copper element, the antibacterial fibers obtained according to the present application possess not only excellent antibacterial performance but also excellent antibacterial durability.

2. In the present application, merely spraying operation is needed to spray complex copper solution onto fibers, which is simple and convenient. Further, the method according to the present application produces no wastewater which otherwise would be produced by impregnation, etc., eliminates the need of discharging or processing wastewater, and thus is simpler and more environmentally friendly in operation.

### BRIEF DESCRIPTION OF THE DRAWINGS

FIG. 1 is a schematic structural diagram of a disc plucker according to one embodiment of the present application;

FIG. 2 is a schematic structural diagram showing a liquid container and a liquid duct of a disc plucker according to one embodiment of the present application;

FIG. 3 is a schematic structural diagram showing the dividing board of a disc plucker according to one embodiment of the present application;

FIG. 4 is a schematic diagram showing the position relationship of a drier and a housing of a disc plucker according to one embodiment of the present application; and

FIG. 5 is a schematic structural diagram showing a drier of a disc plucker according to one embodiment of the present application.

### DESCRIPTION OF THE EMBODIMENTS

The present application will be further explained below in combination with drawings and examples. It is to be noted that, the following examples, if not provided with particular conditions, shall be conducted under conventional conditions or those recommended by the manufacturer, and the raw materials used in the examples are commercially available from the market, unless otherwise clearly stated.

The present application provides a preparation method of an antibacterial fiber, including the steps of opening textile fibers and spraying the textile fibers with organic complex copper solution by a mass ratio of the organic complex copper solution to the textile fiber of 1:(2-4) to provide an antibacterial fiber.

In particular, the textile fiber can be one or two selected from a group consisting of degreasing cotton fiber and artificial cellulose fiber, such as viscose fiber. Such fibers have open hydroxyl groups to be chemically chelated by the complex copper ions in the complex copper solution to firmly bind the complex copper ions on the fiber, thereby providing an antibacterial fiber having both excellent antibacterial performance and antibacterial durability by making use of the antibacterial and anti-virus performance of copper element.

In the field of textile, a cotton fiber, especially fibers for apparel fabric, generally requires scouring and degreasing before it can be used for making clothes (except for colored cotton fibers which have poor wearability when being used for making clothes). Therefore, if a common cotton fiber is used in the method according to the present application, it will generally be subjected to antibacterial treatment (that is, sprayed with organic complex copper solution), followed by carding, drawing, spinning, and weaving, as well as subsequent procedures such as scouring, degreasing, bleaching, dyeing etc., which, especially scouring and degreasing, however, will lead to a relatively large loss of organic copper complexed on the cotton fibers, so that the antibacterial performance of final ready-made clothes is impaired. Therefore, degreasing cotton fibers are adopted in the present application, so that the degreasing cotton fibers, when being used for clothing, especially for apparel fabric, can be carded, drawn, spun, and woven into ready-made clothes having excellent antibacterial performance, without being dyed.

Furthermore, merely spraying organic complex copper solution onto textile fibers is needed in the present application. For better understanding of the present application, the following description is made by taking a cotton fiber as an example of the textile fibers, and mainly focused on exemplary cotton spinning procedures, for example, for the purpose of understanding the procedures in the present application.

In the present application, a variety of conventional spraying processes can be adopted for spraying organic complex copper solution, so as to control the mass ratio of the organic complex copper solution to the textile fibers, and in turn guarantee that a specified amount of organic complex copper solution is sprayed onto a lot, for example, one ton, of textile fibers, to ensure that such lot of the textile fibers are combined with the specified amount of organic complex copper. During subsequent procedures such as carding and drawing, the fibers combined with organic complex copper are uniformly mixed with those not combined with organic copper via carding and drawing, especially drawing, so as to achieve mixing of single fibers and, in turn, thorough mixing of all the fibers. Similar to blend spinning of polyester and cotton, the mixing of fibers made of different materials are conducted mainly by means of carding and drawing procedures to finally provide tops after drawing consisted of, for example, 10 fibers, in which 2 fibers are cotton fibers combined with organic complex copper solution. Therefore, it can be guaranteed that a specified ratio of fibers combined with organic complex copper is finally present in such a lot of products, which can be then subjected to subsequent procedures such as roving, spinning, etc., to provide an antibacterial textile product with uniformly distributed antibacterial fibers.

It can be seen that, the preparation method according to the present application adopts simple and convenient antibacterial treatments to fibers, and produces no wastewater, eliminating the need of wastewater discharging and processing and being simpler and more environment friendly in operation. Further, a potent bactericidal activity is ensured by providing the antibacterial agent on the surface of the fibers. Unlike blend spinning, there is no need to prepare an antibacterial masterbatch or consider the spinnability of the antibacterial masterbatch in the method according to the present application, so that it is simple, convenient and easy to industrialize, greatly saving time and economic costs.

More preferably, the organic complex copper solution is mixed with water in the present application, for example, by a mass ratio of 1:(1-1.5) of organic complex copper solution to water, before spraying.

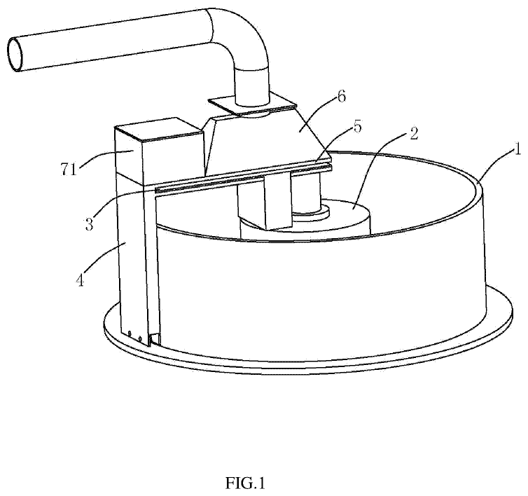

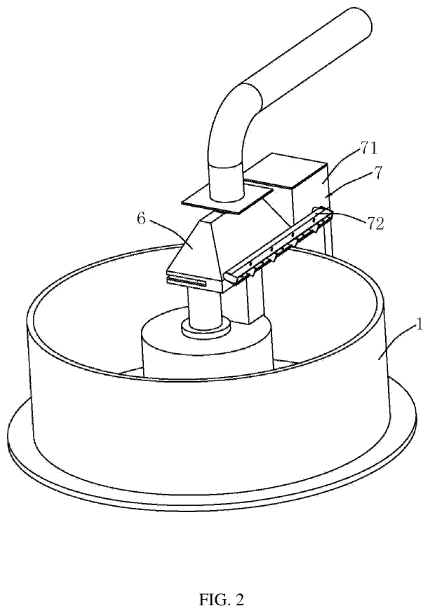

In some embodiments, the opening is conducted by using a disc plucker, and the spraying of organic complex copper solution can be conducted by conventional forms of spraying. For the purpose of reducing the steps for processing textile fibers and achieving simpler and more convenient processing, the spraying of organic complex copper solution in some embodiments are conducted by means of a disc plucker. As shown in FIG. 1 and FIG. 2, a disc plucker includes a disc seat 1 for supporting cotton fibers. A center shaft 2 provided at the center of the disc seat 1, with a driving motor connected with the center shaft 2 and driving the center shaft 2 to rotate. A beater 3 is fixedly connected to the center shaft 2, with one end fixedly connected to the center shaft 2, and the other end connected with a movable bracket 4. The movable bracket 4 is circumferentially movable on the surface of the seat 1 close to the edge thereof, for example, by means of a rolling wheel or a sliding rail. A suction cover 6 is provided above the beater 3, with a suction duct provided thereabove. Cotton fibers are caught by the beater 3, delivered by the suction cover 6 into the suction duct above the suction cover 6, and subsequently processed by a next device connected with the cotton delivery duct.

An inverted U-shaped housing 5 is further provided outside the beater 3, with one end fixedly connected with the center shaft 2, and the other end fixedly connected with the movable bracket 4. The housing 5 is formed by integrally connecting a horizontal plate with two vertical plates positioned at two ends of the horizontal plate. The suction cover 6 is positioned on the horizontal plate, with an opening provided at the joint of the horizontal plate and the suction cover 6 for delivering cotton fibers.

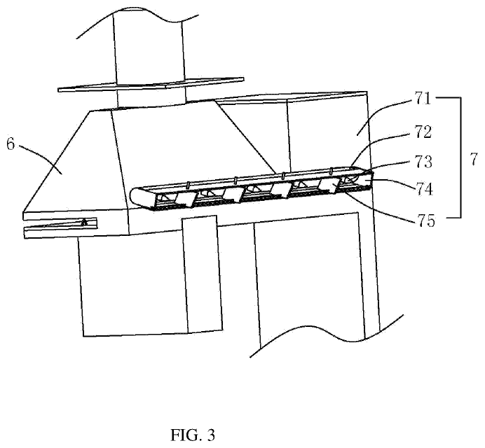

As shown in FIG. 2 and FIG. 3, the disc plucker further includes a spraying device 7, including a liquid container 71 for storing organic complex solution and a liquid duct 72. The liquid container 71 is provided at the upper end of the movable bracket 4. The liquid duct 72 is in communication with the liquid container 71, provided with a flow regulating valve, and fixedly connected with the vertical plate, with the length direction thereof extending along the axis of the beater 3. A plurality of spray heads 73 are provided along the length direction of the liquid duct 72 at equal intervals. The organic complex copper solution in the liquid container 71 is sprayed onto the cotton fibers or other staple fibers in the disc seat 1 via the liquid duct 72 and the spray heads 73, so that the complex copper ions are chemically chelated with open hydroxyl groups on the cotton fibers to combine therewith and provide antibacterial fibers.

The spray heads 73 connected with the liquid duct 72 rotates with the rotation of the beater 3 around the disc seat 1, and sprays the organic complex copper solution toward textile fibers in the disc seat 1. By arranging the spray heads 73 on the vertical plate facing the rotation direction of the beater 3, the spray heads are rotated first and the beater 3 picks textile fibers sprayed with organic complex copper solution while the beater rotates to stir, scatter and open textile fibers. Specified amount of organic complex copper solutions for one lot of textile fibers are stored in the liquid container 71, and the flow rate thereof is adjusted by the flow regulating valve, so that the solution can be used off when the spray heads 73 and the beater 3 rotate a specified number of circles, by which the textile fibers picked earlier by the beater 3 is those combined with complex copper while the textile fibers picked later by the beater 3 is those not combined with complex copper, facilitating subsequent carding and drawing procedures. Alternatively, it is possible that the flow regulating valve is adjusted so that all the textile fibers in the disc seat 1 are picked up when the solution is used off, which renders subsequent procedures simpler and more convenient.

For spray heads 73 arrange at equal intervals, if the distance between spray heads 73 is too small, areas sprayed by the spray heads 73 will overlap with each other, so that part of the textile fibers are sprayed with more complex copper solution while part of the textile fibers are sprayed with less complex copper solution. However, if there is a too large distance between spray heads 73, there will be a void among areas sprayed by the spray heads 73, so that part of the fibers is not sprayed with complex copper solution, especially that the same sites of fibers will be sprayed with no, more, or less complex copper solution, leading to uneven copper distribution on different sites of final textile products.

Therefore, in some embodiments, a dividing component is further provided on the liquid duct 72 in a disc plucker according to the present application. The dividing component includes a shielding cover arranged along the length direction of the liquid duct 72. The shielding cover includes baffle plates 74 positioned at two ends of the liquid duct 72 and a pair of cover plates arranged along the length direction of the liquid duct 72, with an opening formed between the cover plates and the baffle plate 74, facing the disc seat 1. A plurality of tilted dividing plates 75 are arranged between the baffle plates 74, and connected with the baffle plates via a connection strip. The lower side of the dividing plates 75 tilts toward the center shaft 2. Therefore, when the organic complex copper solution is sprayed from the spray heads 73, the providing of the dividing plates 75 can achieve the redistribution of the solution sprayed from the plurality of spray heads 73 and even spraying of the solution from the spray heads 73 onto the textile fibers, to provide, so that there is more uniform copper content in the tops and yarns obtained after drawing, as well as on individual sites of the final textile products. On the other hand, tilting the dividing plates 75 prevents the solution from the spray heads from being sprayed out of the disc seat 1, reducing the loss of the solution.

Preferably, the distance between the spray heads 73 close to the liquid container 71 and the inner wall of the disc seat 1 is 10-15 cm, the distance between the disc seat 1 and the center shaft 2 is 1.8-2.5 m, the liquid duct 72 has a length of 1-1.3 m, there are 6-8 evenly arranged spray heads 73 and 8-10 evenly arranged dividing plates 75, and the spray heads 73 works at a flow rate of 5.0-7.2 L/min and a pressure of 0.3-0.5 MPa. By using these parameters, there will be no overlapping or voids between the areas sprayed by the spray heads 73, or excessive solution on the fibers below the dividing plates 75 due to downward flowing of excessive solution along the dividing plates 75, so that the textile fibers are combined with the complex copper solution more evenly, and the copper content is uniform on all sites of final textile products.

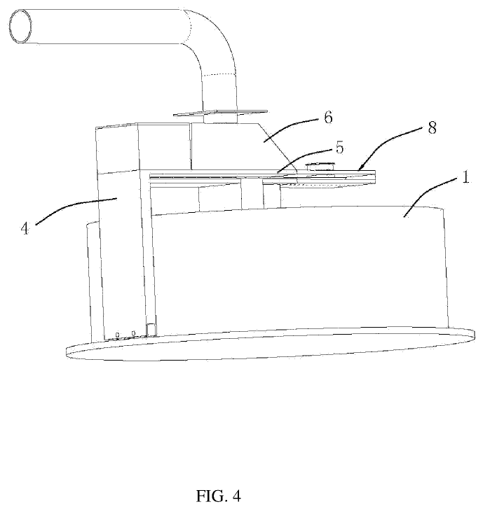

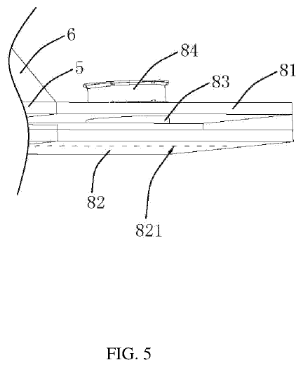

Further, as shown in FIG. 4 and FIG. 5, the disc plucker further includes a drying device 8, for the purpose of preventing the fibers sprayed with the organic complex solution from becoming sticky and influencing subsequent procedures. The drying device 8 includes a casing 81 integrally connected with the housing 5 close to the center shaft 2. An opening is provided in the casing 81, facing the disc seat 1. An air supply panel 82 is provided in the casing 81, and a plurality of air outlets 821 are provided in the air supply panel 182 facing the disc seat 1. A hot air source 84 is connected at the side of the air supply panel 82 away from the air outlets 821 via an air duct 83. In particular, the hot air source 84 can be from an air heater provided on the casing 81 and connected with a power source. The power source is provided on the casing 81 for supplying hot air to the air supply panel 82. Hot air in the air supply panel 82 acts on the textile fibers in the disc seat 1 via the air outlets 821. When the center shaft 2 rotates, the housing 5, the beater 3, and the movable bracket 4 connected with the center shaft 2 are rotated therearound, and the spraying device 7 are correspondingly rotated to spray complex copper solution to textile fibers on the disc seat 1. At the same time, the drying device 8 is rotated with the center shaft 2 to dry the textile fiber on the disc seat 1 until the cotton fibers have a moisture content of 8.5±1 wt % and the viscose fibers have a moisture content of 11±1 wt %, preventing the textile fibers from becoming sticky and influencing subsequent procedures.

The present application is further explained in detail below in combination with Preparation Examples, Examples and Comparison Examples.

Preparation Examples 1-5 are those for preparing an organic complex copper solution.

### Preparation Example 1

A preparation method of organic complex copper solution included the following steps:

S1. Preparing coordinated ionic liquids: mixing urea, caprolactam and acetamide by a weight ratio of 1:0.2:0.2, heating to 100° C., and keeping the temperature at 100° C. for 1 h until caprolactam and urea were dissolved and homogeneously dispersed to provide coordinated ionic liquid;

S2. Preparing organic complex copper solution: weighing and mixing sodium chloride, potassium permanganate, sodium peroxide and copper powder by a mass ratio of 1:1:1:2.5 to provide a solid coordination mixture, adding the solid coordination mixture to the coordinated ionic liquid by a weight ratio of 1:3 under stirring to completely oxidize the copper into univalent copper ions and form coordinated ions with organic compounds in the above coordinated ionic liquid, cooling, and pouring into purified water to provide organic complex copper solution having a copper content of 5.5%, which did not produce precipitates or discolor after standing for 3 days.

### Preparation Example 2

A preparation method of organic complex copper solution included the following steps:

S1. Preparing coordinated ionic liquids: mixing urea, caprolactam and acetamide by a weight ratio of 1:0.3:0.4, heating to 110° C., and keeping the temperature at 110° C. for 0.5 h until caprolactam and urea were dissolved and homogeneously dispersed to provide coordinated ionic liquid;

S2. Preparing organic complex copper solution: weighing and mixing sodium chloride, potassium permanganate, sodium peroxide and copper powder by a mass ratio of 1:2:1:2.9 to provide a solid coordination mixture, adding the solid coordination mixture to the coordinated ionic liquid by a weight ratio of 1:3.5 under stirring to completely oxidize the copper into univalent copper ions and form coordinated ions with organic compounds in the above coordinated ionic liquid, cooling, and pouring into purified water to provide initial organic complex copper solution having a copper content of 5.5%, which did not produce precipitates or discolor after standing for 3 days.

### Preparation Example 3

A preparation method of organic complex copper solution included the following steps:

S1. Preparing coordinated ionic liquids: mixing urea, caprolactam and acetamide by a weight ratio of 1:0.4:0.4, heating to 120° C., and keeping the temperature at 120° C. for 1 h until caprolactam and urea were dissolved and homogeneously dispersed to provide coordinated ionic liquid;

S2. Preparing organic complex copper solution: weighing and mixing sodium chloride, potassium permanganate, sodium peroxide and copper powder by a mass ratio of 1:2:2:2.9 to provide a solid coordination mixture, adding the solid coordination mixture to the coordinated ionic liquid by a weight ratio of 1:3.5 under stirring to completely oxidize the copper into univalent copper ions and form coordinated ions with organic compounds in the above coordinated ionic liquid, cooling, and pouring into purified water to provide initial organic complex copper solution having a copper content of 5.5%, which did not produce precipitates or discolor after standing for 3 days.

### Preparation Example 4

A preparation method of organic complex copper solution was conducted according to the method in Preparation Example 2, except that, urea, caprolactam and acetamide were mixed by a weight ratio of 1:0.4:0.3 in the step of preparing coordinated ionic liquid.

### Preparation Example 5

A preparation method of organic complex copper solution was conducted according to the method in Preparation Example 4, except that, sodium chloride, potassium permanganate, sodium peroxide, and copper powder were mixed by a weight ratio of 1:1:2:2.8 in the step of preparing organic complex copper solution.

### Preparation Example 6

A preparation method of organic complex copper solution was conducted according to the method in Preparation Example 5, except that, the solid coordinate mixture and the coordinate ionic liquid were mixed by a weight ratio of 1:3.2 in the step of preparing organic complex copper solution.

### Preparation Example 7

A preparation method of organic complex copper solution was conducted according to the method in Preparation Example 6, except that, in the step of preparing organic complex copper solution, the solid coordination mixture was added to the coordinated ionic liquid under stirring to completely oxidize the copper into univalent copper ions and form coordinated ions with organic compounds in the above coordinated ionic liquid, and the resultant mixture was cooled and poured into purified water to provide initial organic complex copper solution having a copper content of 5%, which did not produce precipitates or discolor after standing for 3 days.

### EXAMPLES

### Example 1

A preparation method of an antibacterial fiber included the following steps of:

opening degreasing cotton fibers in the above disc plucker, spraying organic complex copper solution prepared according to Preparation Example 1 thereon by a mass ratio of organic complex copper solution to textile fibers of 1:2, and drying the cotton fibers until a moisture content of 8.5 wt % to provide antibacterial fibers.

### Example 2

A preparation method of an antibacterial fiber was conducted according to the method in Example 1, except that, the organic complex copper solution and the textile fibers were used by a mass ratio of 1:4 to prepare the antibacterial fibers.

### Example 3

A preparation method of an antibacterial fiber was conducted according to the method in Example 1, except that, the organic complex copper solution and the textile fibers were used by a mass ratio of 1:3 to prepare the antibacterial fibers.

### Examples 4-8

A preparation method of an antibacterial fiber was conducted according to the method in Example 3, except that, the organic complex copper solution prepared according to Preparation Examples 2-6 were used as the organic complex copper solution.

### Examples 9

A preparation method of an antibacterial fiber was conducted according to the method in Example 3, except that, the organic complex copper solution prepared according to Preparation Example 7 was used as the organic complex copper solution.

### Examples 10

A preparation method of an antibacterial fiber was conducted according to the method in Example 9, except that, the organic complex copper solution was mixed by a mass ratio of 1:1 and then sprayed.

### Examples 11

A preparation method of an antibacterial fiber was conducted according to the method in Example 10, except that, the organic complex copper solution was mixed by a mass ratio of 1:1.5 and then sprayed.

### Examples 12

A preparation method of an antibacterial fiber was conducted according to the method in Example 10, except that, the organic complex copper solution was mixed by a mass ratio of 1:1.25 and then sprayed.

### Examples 13

A preparation method of an antibacterial fiber was conducted according to the method in Example 3, except that, viscose fibers were opened in the disc plucker, sprayed with organic complex copper solution prepared according to Preparation Example 1 by a mass ratio of organic complex copper solution to textile fibers of 1:3, and dried until the viscose fibers have a moisture content of 11 wt % to provide antibacterial fibers.

### Comparison Example 1

A preparation method of an antibacterial fiber was conducted according to the method in Example 12, except that, in the step of preparing organic complex copper solution, the solid coordination mixture was added to the coordinated ionic liquid under stirring, and the resultant mixture was cooled and poured into purified water to provide an initial organic complex copper solution having a copper content of 4.5%, which did not produce precipitates or discolor after standing for 3 days.

Then, the initial organic complex copper solution having a copper content of 4.5% was sprayed onto antibacterial fibers according to the method in Example 12.

### Comparison Example 2

A preparation method of an antibacterial fiber was conducted according to the method in Example 12, except that, the mass ratio of the organic complex copper solution to the textile fibers was 1:1.5.

### Comparison Example 3

A preparation method of an antibacterial fiber was conducted according to the method in Example 12, except that, the mass ratio of the organic complex copper solution to the textile fibers was 1:5.

The present application further provided an antibacterial textile product made from the antibacterial fibers prepared according to the above Examples.

Performance Test

1. Antibacterial Test Experiments

The antibacterial fibers obtained according to Examples in the present application and

Comparison Examples were made into textile products, and antibacterial performance was tested for the textile products obtained in Examples 1-12 and Comparison Example 1 according to AATCC100-2012 Textile Products Antibacterial Performance Test. The test samples were a round piece of fabric having a diameter of 4.8 cm. 4 parallel test were made and averaged. Methicillin resistant Staphylococcus aureus ATCC33591 was used as a detection bacterium, with an inoculum volume of 1 mL and a bacteria concentration of 1.1×10⁵ cfu/ml. The number of bacteria obtained after eluting at “0” h contact time and that obtained after eluting at “24” h contact time were determined, respectively, to calculate the percentage of bacteria reduction, and the detection results of bacteria reduction rate are shown in Table 1 below.

TABLE 1
Antibacterial Performance

| | Detection Items | | | | | | | |
|---|---|---|---|---|---|---|---|---|
| | Exam. 1 | Exam. 2 | Exam. 3 | Exam. 4 | Exam. 5 | Exam. 6 | Exam. 7 | Exam. 8 |
| Bacteria | 97.3% | 96.8% | 97.8% | 98.2% | 98.3% | 98.5% | 98.9% | 99.1% |
| Reduction/% | | | | | | | | |
| | Detection Items | | | | | | | |
| | | | | | | Com. | Com. | Com. |
| | Exam. 9 | Exam. 10 | Exam. 11 | Exam. 12 | Exam. 13 | Exam. 1 | Exam. 2 | Exam. 3 |
| Bacteria | 99.3% | 99.9% | 99.5% | 99.7% | 98.1% | 92.5% | 99.7% | 92.1% |
| Reduction/% | | | | | | | | |

It can be seen from the above Table 1 that, the textile products prepared from the antibacterial fibers obtained in Examples of the present application has excellent antibacterial performance. From the results of Example 3, Example 9 and Comparison Example 1, it can be seen that, when the organic complex copper solution having a copper content of 5.0% was used for spraying, the obtained textile products provided a bacteria reduction rate of 95% or higher, while antibacterial performance was greatly reduced when the content of copper was below 5.0%, and substantially kept unchanged when the content of copper was further increased, which is not good for human body due to excessive copper content, instead.

From the results of Examples 3 and 6-8 of the present application, it can be seen that, the antibacterial fibers obtained at a weight ratio of urea to caprolactam to acetamide of 1:0.4:0.3 has a better antibacterial performance than those obtained at a weight ratio of urea to caprolactam to acetamide of 1:0.3:0.4, the antibacterial fibers obtained at a mixing weight ratio of sodium chloride to potassium permanganate to sodium peroxide to copper powder of 1:1:2:2.8 has a better antibacterial performance than those obtained at a mixing weight ratio of sodium chloride to potassium permanganate to sodium peroxide to copper powder of 1:0.3:0.4, and the antibacterial performance of the antibacterial fibers obtained at a mixing weight ratio of solid coordinate mixture to coordinated ionic liquid of 1:3.2 was further improved.

Further, from the results of Examples 9 and 10-12 of the present application, it can be seen that, the antibacterial textile cloth obtained by mixing the organic complex copper solution and water and spraying has increased antibacterial performance, which, presumably, lies in that, mixing the organic complex copper solution with water and spraying disperses more organic copper onto more textile fibers, so that each top contains a larger number of copper-containing fibers after drawing, and in turn, the final textile products have increased antibacterial performance.

2. Durability

Textile products obtained in Example 3, Example 9, Example 10, Example 13, and Comparison Examples 1-2 were washed for 50, 100 and 200 times, and tested regarding antibacterial performance according to AATCC100-2012 Textile Products Antibacterial Performance Test. The test samples were a round piece of fabric having a diameter of 4.8 cm. Methicillin resistant Staphylococcus aureus ATCC33591 was used as a detection bacterium, with an inoculum volume of 1 mL. In addition, copper content on the textile products was detected to determine the loss of copper content, results of which are shown in Table 2 below.

TABLE 2
Durability Test

| | Washing for 50 times | | Washing for 100 times | | Washing for 200 times | |
|---|---|---|---|---|---|---|
| | Bacteria | Loss of Cu | Bacteria | Loss of Cu | Bacteria | Loss of Cu |
| Items | Reduction | content | Reduction | content | Reduction | content |
| Exam. 3 | 97.7% | 0.02% | 97.5% | 0.05% | 97.4% | 0.09% |
| Exam. 9 | 99.3% | 0.01% | 99.1% | 0.03% | 99.0% | 0.04% |
| Exam. 10 | 99.8% | 0.01% | 99.6% | 0.01% | 99.5% | 0.03% |
| Exam. 13 | 97.9% | 0.02% | 97.7% | 0.04% | 97.5% | 0.06% |
| Com. Exam. 1 | 90.5% | 0.24% | 84.7% | 0.57% | 78.6% | 0.89% |
| Com. Exam. 2 | 99.6% | 0.06% | 99.1% | 0.12% | 98.4% | 0.31% |

From the above Table 2, it can be seen that, the antibacterial non-woven fabrics obtained according to the present application has excellent antibacterial durability. In addition, chemical chelation is formed between specific complex copper ions with fibers in the present application, the amount of organic complex copper solution to be added is decreased, and the obtained textile products has a relatively light color and is more convenient for dyeing. Further, it can be observed that the color at all sites of the textile products is uniform, and the detection on the copper content at different sites of woven fabrics also gives the conclusion that the color at all sites of the textile products is uniform.

The above particular examples are merely provided for explaining the present application, not intended to limit the present application in any way. Modifications to these examples without paying creative labor can be made by those skilled in the art after reading the present disclosure, but fall within the scope of protection defined by the appended claims of the present application.

What is claimed is:

1. A preparation method of an antibacterial fiber, comprising the following steps of:
opening textile fibers, spraying the textile fibers with organic complex copper solution by a mass ratio of the organic complex copper solution to the textile fiber of 1: (2-4), and drying to provide an antibacterial fiber.

2. The preparation method of an antibacterial fiber according to claim 1, wherein the organic complex copper solution is mixed with water by a mass ratio of 1:(1-1.5) of organic complex copper solution to water, before spraying.

3. The preparation method of an antibacterial fiber according to claim 1, wherein the textile fibers are one or two selected from the group consisting of degreasing cotton fiber and artificial cellulose fiber.

4. The preparation method of an antibacterial fiber according to claim 1, wherein the opening is conducted by using a disc plucker, and the disc plucker comprises a disc seat configured for supporting fibers, a center shaft provided at a center of the disc seat, a driving motor connected with the center shaft, a beater fixedly connected to the center shaft, a suction cover provided above the beater and a delivery duct provided above the suction cover;
the disc plucker further comprises a movable bracket connected to one end of the beater and circumferentially movable on the surface of the disc seat close to the edge thereof;
the disc plucker further comprises a housing provided outside the beater, with one end fixedly connected to the center shaft and the other end fixedly connected to the movable bracket;
the disc plucker further comprises a spraying device, and the spraying device comprises a liquid container provided at an upper end of the movable bracket for storing organic complex solution and a liquid duct in communication with the liquid container;
the disc plucker further comprises a drying device, the drying device comprises a casing connected with the housing, an opening facing the disc seat is provided in the casing, an air supply panel is provided in the casing, a plurality of air outlets facing the disc seat are provided in the air supply panel, and a hot air source is connected at the side of the air supply panel away from the air outlets via an air duct.

5. The preparation method of an antibacterial fiber according to claim 4, wherein the disc plucker further comprises a dividing component, the dividing component comprises a shielding cover arranged along the length direction of the liquid duct, the shielding cover comprises baffle plates positioned at two ends of the liquid duct and a pair of cover plates arranged along the length direction of the liquid duct, with an opening facing the disc seat formed between the cover plates and the baffle plates, a plurality of tilted dividing plates are arranged between the baffle plates and connected with the baffle plates via a connection strip, and the lower side of the dividing plates tilts toward the center shaft.

6. The preparation method of an antibacterial fiber according to claim 1, wherein the organic complex copper solution is prepared by the steps of:
preparing coordinated ionic liquids: uniformly mixing urea, caprolactam and acetamide, heating, and keeping the temperature until caprolactam and urea are dissolved and homogeneously dispersed to provide coordinated ionic liquid; and
preparing organic complex copper solution: adding a solid coordination mixture containing sodium chloride, potassium permanganate, sodium peroxide, and copper powder to the coordinated ionic liquid under stirring, reacting, cooling, and pouring into purified water to provide an organic complex solution having a copper content of 5-5.5 wt %.

7. The preparation method of an antibacterial fiber according to claim 6, wherein, in the step of preparing coordinated ionic liquid, urea, caprolactam and acetamide are mixed by a weight ratio of 1:(0.2-0.4):(0.2-0.4), a temperature for heating after uniformly mixing is 100-120° C., and the temperature is kept for 0.5-1 h.

8. The preparation method of an antibacterial fiber according to claim 6, wherein, in the step of preparing organic complex copper solution, sodium chloride, potassium permanganate, sodium peroxide, and copper powder are mixed by a weight ratio of 1:(1-2):(1-2):(2.5-2.9), and the solid coordination mixture and the coordinated ionic liquid are mixed by a weight ratio of 1:(3-3.5).

9. The preparation method of an antibacterial fiber according to claim 6, wherein, in the step of preparing coordinated ionic liquid, urea, caprolactam, and acetamide are mixed by a weight ratio of 1:0.4:0.3;
in the step of preparing organic complex copper solution, sodium chloride, potassium permanganate, sodium peroxide, and copper powder are mixed by a weight ratio of 1:1:2:2.8, and the solid coordination mixture and the coordinated ionic liquid are mixed by a weight ratio of 1:3.2.

10. An antibacterial fiber made by the preparation method according to claim 1.

11. An antibacterial textile product made from the antibacterial fiber according to claim 10.
